(19) United States
(12) Patent Application Publication
(10) Pub. No.: US 2015/0285562 A1
(43) Pub. Date: Oct. 8, 2015

(54) VAPOR CHAMBER HEAT SINK AND METHOD FOR MAKING THE SAME

(71) Applicant: Tsung-Hsien Huang, I-Lan Hsien (TW)

(72) Inventor: Tsung-Hsien Huang, I-Lan Hsien (TW)

(21) Appl. No.: 14/319,065

(22) Filed: Jun. 30, 2014

(30) Foreign Application Priority Data
Apr. 3, 2014 (CN) 201410132762.7

(51) Int. Cl. F28D 15/02; B23P 15/26

(52) U.S. Cl. CPC F28D 15/02; B23P 15/26

(57) ABSTRACT

A vapor chamber heat sink includes an upper base having radiation fins formed of a top wall thereof by chipping, and a lower base bonded to a bottom wall of the upper base through a single soldering process, enabling a recessed chamber in the lower base to form an enclosed inner chamber in a vacuum status.

### BACKGROUND OF THE INVENTION

(a) Field of the Invention

The present invention relates to heat sink technology, and more particularly to a vapor chamber heat sink that has radiation fins formed integral with an upper base thereof and that can be made through one single soldering process.

(b) Description of the Prior Art

A vapor chamber is a high-end thermal management device for installation in a narrow space or for mating a large area electronic heat emitting component to rapidly dissipate heat. A vapor chamber generally comprises an upper base and a lower base. The upper base and the lower base are bonded together with an enclosed inner chamber defined therebetween. Support members and wick structure are provided in the enclosed inner chamber. Further, a work fluid is filled in the enclosed inner chamber. In application, a vapor chamber is attached to the surface of an electronic heat-emitting component (such as a CPU) for dissipating heat rapidly.

In order to enhance the heat dissipation performance of a vapor chamber, a secondary soldering process can be employed to bond radiation fins to the top wall of the upper base of the vapor chamber. Thus, heat energy absorbed by the vapor chamber can be transferred to the radiation fins for dissipation into the atmosphere rapidly. According to the prior art design, a primary soldering process is employed to bond the upper base and the lower base together, and a secondary soldering process is employed to bond the radiation fins to the top wall of the upper base. The application of the secondary soldering process at a high temperature can cause structural damage to the vapor chamber. In consequence, the yield rate of attaching conventional radiation fins to vapor chambers is low. An improvement in this regard is desired.

Further, when bonding the radiation fins to the top wall of the upper base with a solder material, a capillary action can occur in the junction between the top wall of the upper base and the radiation fins, leading to generation of heat resistance and heat-transfer obstruction and lowering the heat dissipation performance.

### SUMMARY OF THE INVENTION

The present invention has been accomplished under the circumstances in view. It is therefore the main object of the present invention to provide a vapor chamber heat sink, which comprises an upper base having radiation fins formed of a top wall thereof by chipping, and a mating lower base bonded to a bottom wall of the upper base through a single soldering process, enabling a recessed chamber in the lower base to form an enclosed inner chamber in a vacuum status. Because the upper base has integral radiation fins at the top wall thereof, the upper base and the lower base can be bonded together to form the desired vapor chamber heat sink through one single soldering process, eliminating a secondary high temperature soldering process that can cause structural damage to the vapor chamber heat sink. Thus, the invention improves the vapor chamber heat sink yield and solves current manufacturing difficulties.

Further, because the upper base has integral radiation fins at the top wall thereof, the upper base and the lower base can be bonded together to form the desired vapor chamber heat sink through one single soldering process, and thus the fabrication of the vapor chamber heat sink is easy and rapid.

Further, because the radiation fins are formed integral with the top wall of the upper base, the radiation fins and the upper base are in one piece, eliminating any capillarity or thermal resistance between the radiation fins and the upper base, and therefore, the upper base and the radiation fins can transfer heat directly, enhancing the heat dissipation performance.

### BRIEF DESCRIPTION OF THE DRAWINGS

FIG. 1 is an exploded view of a vapor chamber heat sink in accordance with the present invention.

FIG. 2 is a top perspective view of the vapor chamber heat sink in accordance with the present invention.

FIG. 3 is a sectional side view of the vapor chamber heat sink in accordance with the present invention.

FIG. 4 is a sectional side view of an alternate form of the vapor chamber heat sink in accordance with the present invention.

FIG. 5 is a flow chart explaining the fabrication of the vapor chamber heat sink in accordance with the present invention.

### DETAILED DESCRIPTION OF THE PREFERRED EMBODIMENTS

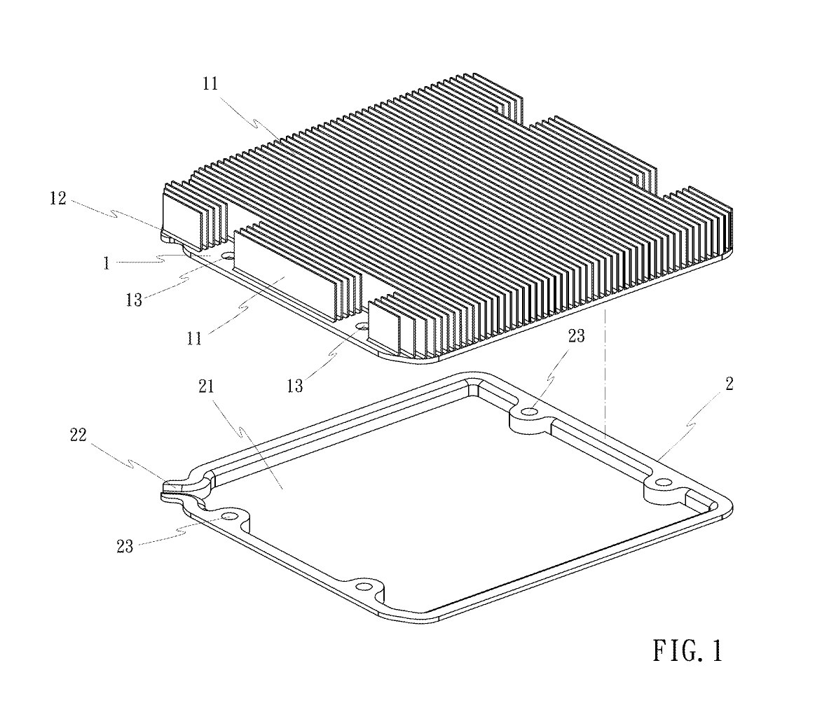

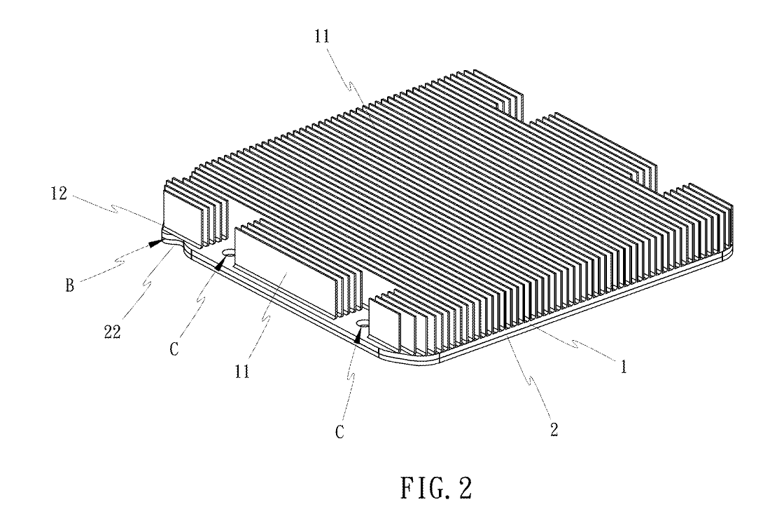

Referring to FIGS. 1 and 2, a vapor chamber heat sink in accordance with the present invention is shown. As illustrated, the vapor chamber comprises an upper base 1 and a lower base 2.

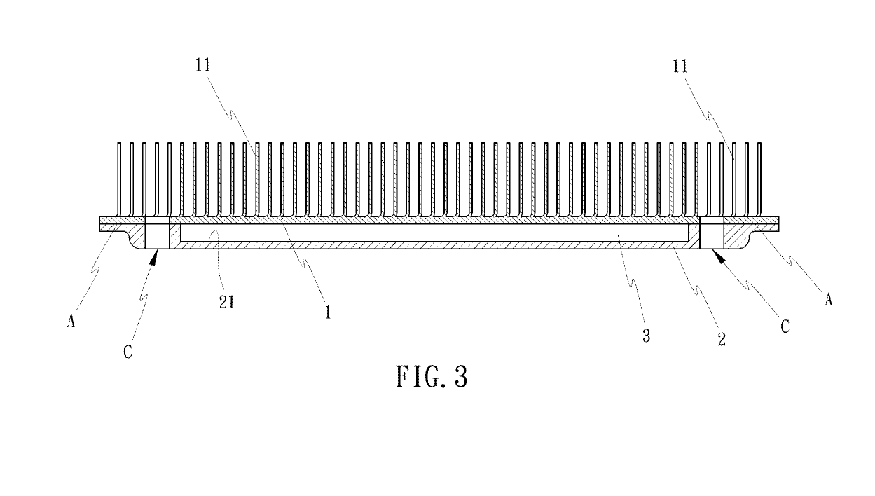

The upper base 1 has radiation fins 11 formed of a top wall thereof by chipping. There is no restriction limiting the fin pitch and size of the radiation fins 11, however, the radiation fins 11 and the upper base 1 are made in one piece. The lower base 2 mates the upper base 1, comprising a recessed chamber 21 at a top side thereof. When the lower base 2 and the upper base 1 are secured together, the recessed chamber 21 is sealed, forming an inner chamber 3 (see FIG. 3).

Because the upper base 1 has integral radiation fins 11 at the top wall thereof, the upper base 1 and the lower base 2 can be bonded together to form the desired vapor chamber heat sink through one single soldering process, thus eliminating a secondary high temperature soldering process that can cause structural damage to the vapor chamber heat sink. Thus, the invention improves the vapor chamber heat sink yield and solves current manufacturing difficulties.

The aforesaid single soldering process is to bond the junction A between the upper base 1 and the lower base 2 (see FIG. 3). Thus, the vapor chamber heat sink can be made easily through one single soldering process.

Similar to a conventional vapor chamber, the upper base 1 and the lower base 2 each have a connection portion 12 or 22. The connection portions 12 of the upper base 1 and the connection portion 22 of the lower base 2 are bonded together to form a work fluid filling hole B. Through the work fluid filling hole B, a work fluid is filled into the inner chamber 3, and then the inner chamber 3 is drawn down to a vacuum. Because this procedure is of the known technique, no further detailed description in this regard will be necessary.

Further, through holes 13 and 23 are respectively located in the border area of the upper base 1 and the border area of the lower base 2. After the upper base 1 and the lower base 2 are bonded together, the through holes 13 in the upper base 1 are respectively aligned with the through holes 23 in the lower base 2, forming mounting through holes C for fastening to a PC board.

Because the radiation fins 11 are formed integral with the top wall of the upper base 1, the radiation fins 11 and the upper base are in one piece, eliminating any capillarity or thermal resistance between the radiation fins 11 and the upper base 1. Therefore, the upper base 1 and the radiation fins 11 can transfer heat directly, thus enhancing heat dissipation performance.

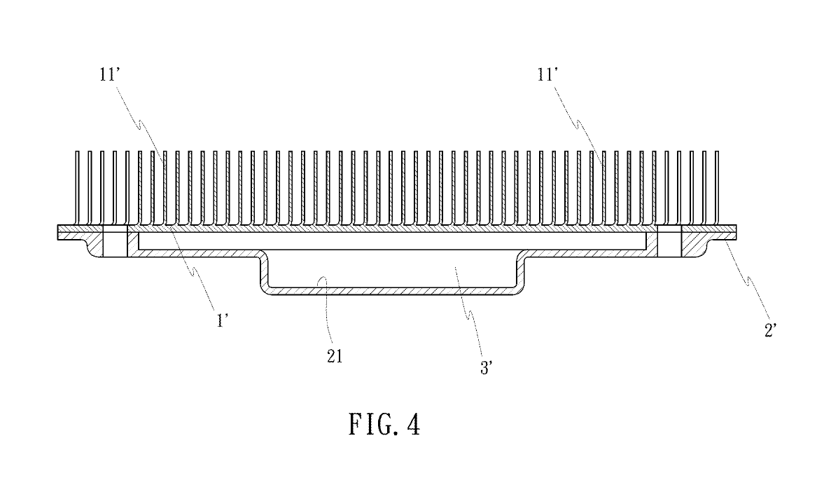

Referring to FIG. 4, an alternate form of the vapor chamber heat sink in accordance with the present invention is shown. According to this embodiment, the shapes and sizes of the upper base l′, the radiation fins 11′ and the lower base 2′ are relatively changed to fit different requirements. Further, in the embodiment shown in FIGS. 1-3, the recessed chamber 21 of the lower base 2 is a flat chamber. In this alternate form, the recessed chamber 21′ of the lower base 2′ is a stepped chamber that can be sealed to form a stepped inner chamber 3′.

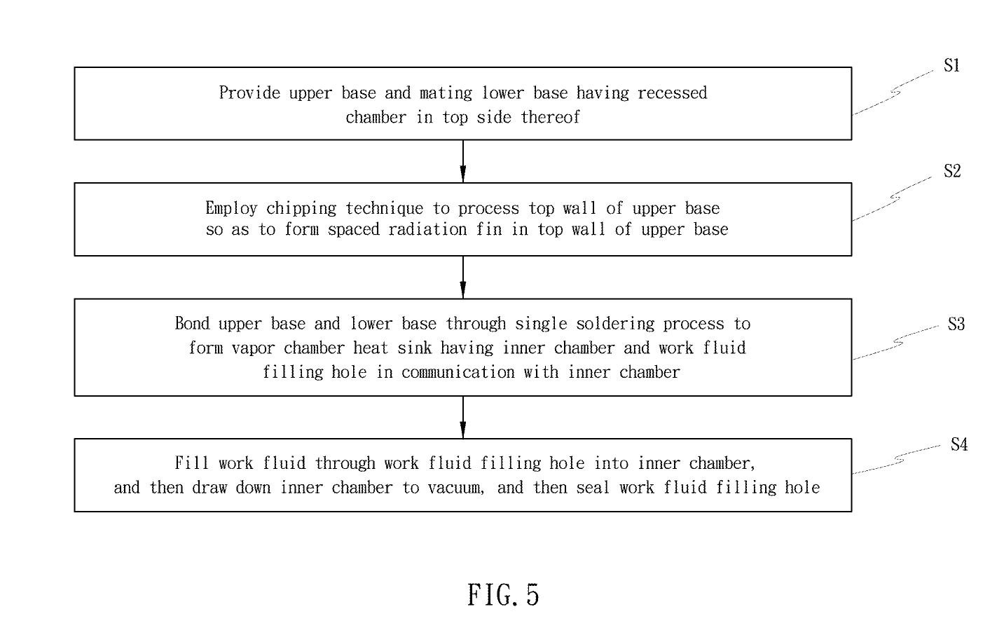

Referring to FIG. 5, a method for making vapor chamber heat sink comprises the steps as follows:
1. Step S1: providing an upper base and a mating lower base having a recessed chamber at a top side thereof;
2. Step S2: employing a chipping technique to process a top wall of the upper base so as to form spaced radiation fin on the top wall of the upper base;
3. Step S3: bonding the upper base and the lower base through a single soldering process to form a vapor chamber heat sink having an inner chamber and a work fluid filling hole in communication with the inner chamber; and
4. Step S4: filling a work fluid through the work fluid filling hole into the inner chamber, and then drawing down the inner chamber to a vacuum, and then sealing the work fluid filling hole.

In conclusion, the invention provides a vapor chamber heat sink and method of making same. The structural feature of the vapor chamber heat sink and its manufacturing method are non obvious when compared with the prior art designs. More particularly, the vapor chamber heat sink can be made through one single soldering process. Thus, the invention improves vapor chamber heat sink yield and solves current manufacturing difficulties.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A heat sink assembly, comprising an upper base and a lower base, wherein:
said upper base comprises a plurality of radiation fins integrally formed of a top wall thereof by chipping;
said lower base bonded to a bottom wall of said upper base opposite to said radiation fins, said lower base comprising a recessed chamber located at a top side thereof and sealed by the bottom wall of said upper base to form an enclosed inner chamber in a vacuum status.

2. The vapor chamber heat sink as claimed in claim 1, wherein said upper base comprises a connection portion; said lower base comprises a connection portion bonded with the connection portion of said upper base to form a work fluid filling hole that is sealed after filling of a work fluid through said work fluid filling hole into said enclosed inner chamber.

3. The vapor chamber heat sink as claimed in claim 1, wherein said upper base comprises a plurality of through holes; said lower base comprises a plurality of through holes respectively connected to the through holes of said upper base to form respective mounting through holes.

4. The vapor chamber heat sink as claimed in claim 1, wherein said recessed chamber of said lower base is a flat chamber.

5. The vapor chamber heat sink as claimed in claim 1, wherein said recessed chamber of said lower base is a stepped chamber.

6. A method for making a vapor chamber heat sink, comprising the steps of:
(i) providing an upper base and a mating lower base having a recessed chamber at a top side thereof;
(ii) employing a chipping technique to process a top wall of said upper base so as to form spaced radiation fins on the top wall of said upper base;
(iii) bonding said upper base and said lower base through a single soldering process to form a vapor chamber heat sink having an inner chamber and a work fluid filling hole in communication with said inner chamber; and
(iv) filling a work fluid through said work fluid filling hole into said inner chamber, and then drawing down said inner chamber to a vacuum, and then sealing said work fluid filling hole.
